(19) United States
(12) Patent Application Publication
(10) Pub. No.: US 2009/0288525 A1
(43) Pub. Date: Nov. 26, 2009

(54) Screw positioning sleeve assembly

(76) Inventor: SHIOU-E CHEN, Daliao Township (TW)

Correspondence Address: Dr. BANGER SHIA, 102 Lindencrest Ct., Sugar Land, TX, 77479-5201, US

(21) Appl. No.: 12/326,850

(22) Filed: Dec. 2, 2008

Related U.S. Application Data
(63) Continuation-in-part of application No. 12/124,603, filed on May 21, 2008, now abandoned.

(51) Int. Cl. B25B 23/08

(52) U.S. Cl. 81/451

(57) ABSTRACT

A screw positioning sleeve assembly capable of quickly connecting a locking tool comprises an inner sleeve slideably received in an outer sleeve, and the moving distance of the outer sleeve varies with the depth of the locking groove, so that the inner sleeve can be engaged with an ordinary tool rod or a screwdriver to screw or unscrew a screw. When screwing or unscrewing, a magnet in the outer sleeve can attract the screw. During the screwing and unscrewing process, the positioning sleeve can move towards the screw to make the magnet keep attracting the screw, thus preventing the screw from screwing or unscrewing falling off. It is noted that the rod body of the tool rod or the screwdriver can connect with the screw positioning sleeve assembly without any additional preformed structure. Therefore, the scope of applicability of the screw positioning sleeve assembly is enlarged considerably.

This application is a continuation of part of U.S. patent application Ser. No. 12/124,603, which claims the benefit of the earlier filing date of Mat 21, 2008. Claim 1 of this application is added with the limitation of “a moving distance of the outer sleeve varies with a depth of the locking groove of the screw” and amended by changing the tool rod to the locking tool, claim 2 and 4-5 of this application correspond to the previous claim 2 and 4-5 of the U.S. patent application Ser. No. 12/124,603, claim 3 of this application is new.

### BACKGROUND OF THE INVENTION

1. Field of the Invention

The present invention relates to a screw positioning sleeve assembly, and more particularly to a screw positioning sleeve assembly capable of quickly connecting a conventional tool rod or screwdriver for screwing or unscrewing a screw.

2. Description of the Prior Arts

Referring to FIG. 1, U.S. Pat. No. 6,520,509, entitled “screw guide device with drill bit/screw bit and counter sink/drill stop means”, discloses a screw guide device essentially provided with a movable sleeve 92 on the front end of a tool rod 91. A tool head 93 is disposed in one end of the tool rod 91 for screwing or unscrewing a screw 94. The sleeve 92 has one end mounted on the tool rod 91 and provided with an elastic engaging portion 921, and the other end provided with an inwards-protruding stopping portion 922 and a cooperating end opening 923.

By such arrangements, with the structure design of the stopping portion 922 and the cooperating end opening 922, the sleeve 92 can be pulled to prevent the screw 94 from slanting due to swaying during to screwing operation, in other words, the sleeve 92 is mainly designed to put the screw 94 in the right position to enable the screwing operation to be successfully performed but not aim at solving the problems between the tool head 93 and the screw 94. However, U.S. Pat. No. 7,124,665 invented by the inventor of the present invention, entitled “screw positioning device for a screwdriver” was developed to solve the problems between the tool head and the screw during the screwing operation, and the present invention is also improved for solving the problems caused between the screw head and the screw, and more particularly improved from U.S. Pat. No. 7,124,665, which is also invented by the inventor of the present invention.

FIG. 2 shows the screw positioning device disclosed in U.S. Pat. No. 7,124,665, which is invented by the inventor of the present invention. An annular recess 11 is defined at the front end of an outer periphery of a tool rod 10, and the annular recess 11 has certain travel length, so that a positioning sleeve 12 with a magnet 122 disposed in a cutting groove 121 thereof can be directly engaged in the annular recess of the tool rod 10. By such arrangements, when screwing or unscrewing, the tool rod 10 cooperates with a tool head 13 to screw or unscrew a screw, the magnet 122 can attract the screw. During the screwing and unscrewing process, the positioning sleeve can move towards the screw to make the magnet keep attracting the screw, thus preventing the screw from screwing or unscrewing falling off.

Abovementioned structure is quite simple and practical, and it provides a practical tool with low cost, but after further study, the inventor of the present invention discovered that an annular recess must be preformed in the outer surface of the front end of the tool, and then the tool rod can cooperate with the positioning sleeve. Therefore, the tool rod must be particularly manufactured, and the screw positioning device cannot be applied to a conventional tool rod.

Therefore, if an ordinary tool rod without the annular recess can be fitted on the positioning sleeve, the positioning sleeve will be very easy to use and its scope of applicability will be substantially enlarged.

The present invention has arisen to mitigate and/or obviate the afore-described disadvantages.

### SUMMARY OF THE INVENTION

The primary objective of the present invention is to provide a screw positioning sleeve assembly capable of quickly connecting a locking tool, which comprises an inner sleeve slideably received in an outer sleeve, and the moving distance of the outer sleeve varies with the depth of the locking groove of the screw, so that the inner sleeve can be engaged with an ordinary tool rod or a screwdriver to screw or unscrew a screw. It is noted that the rod body of the tool rod or the screwdriver can be engaged in the screw positioning sleeve assembly of the present invention without any additional preformed structure. Therefore, the scope of applicability of the screw positioning sleeve assembly is enlarged considerably.

### BRIEF DESCRIPTION OF THE DRAWINGS

FIG. 1 is a cross-sectional view of a conventional screw guide device disclosed in U.S. Pat. No. 6,520,509;

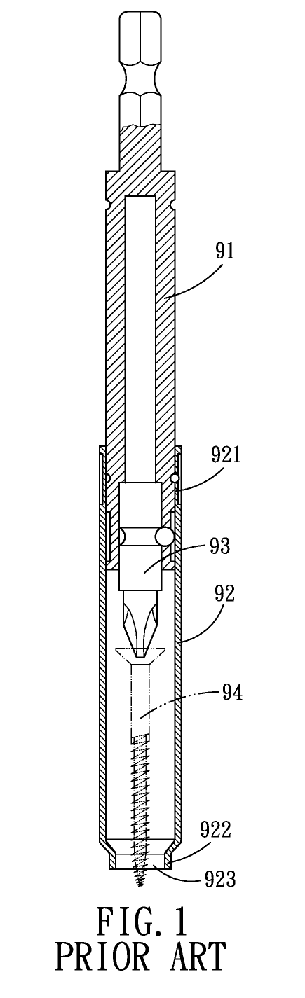

FIG. 2 is an exploded view of a screw positioning device for a screwdriver of the U.S. Pat. No. 7,124,665;

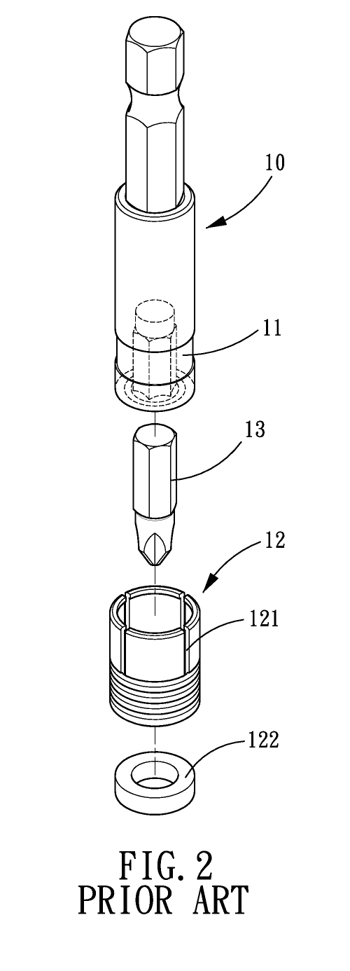

FIG. 3 is an exploded view of a screw positioning sleeve assembly in accordance with the present invention and a screwdriver;

FIG. 4 is an assembly view of the screw positioning sleeve assembly in accordance with the present invention and the screwdriver;

FIG. 5 is a perspective view showing that the screw positioning sleeve assembly in accordance with the present invention is connected to the screwdriver;

FIG. 6 is a longitudinal sectional view showing that the screw positioning sleeve assembly in accordance with the present invention is connected to the screwdriver;

FIG. 7 is a perspective view showing that the screw positioning sleeve assembly in accordance with the present invention is screwing or unscrewing a screw;

FIG. 8 is a comparative view of screws with different depths of locking grooves;

FIG. 9 is a longitudinal sectional view showing that the screw positioning sleeve assembly in accordance with the present invention is defined with an O-shaped ring for connecting with the screwdriver;

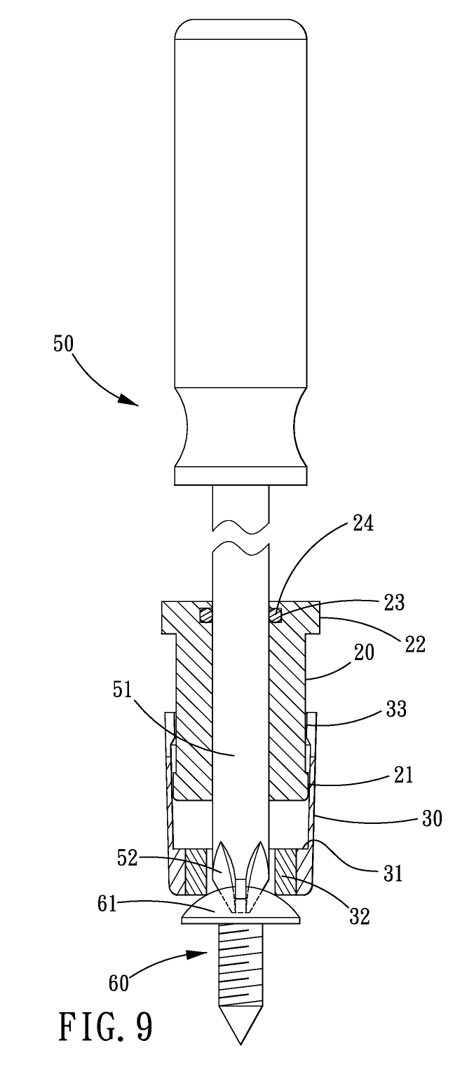

FIG. 10 is a longitudinal sectional view showing that the screw positioning sleeve assembly in accordance with the present invention is defined with a C-shaped clasp for connecting with the screwdriver;

FIG. 11 is a longitudinal sectional view of FIG. 10 showing that the screw positioning sleeve assembly in accordance with the present invention is connected to a tool rod; and

FIG. 12 is a longitudinal sectional view showing that the screw positioning sleeve assembly in accordance with the present invention is connected to the tool rod.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

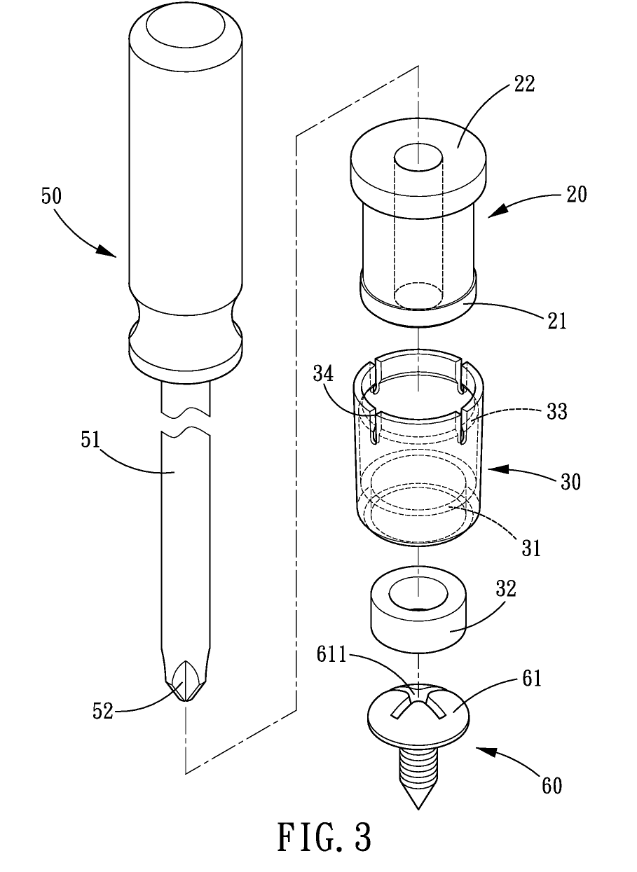

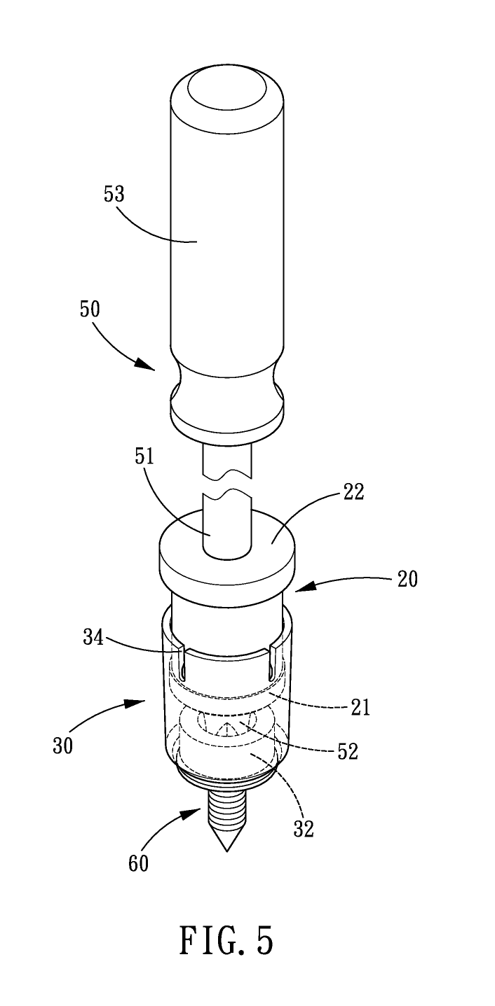

Referring to FIGS. 3-7, the present invention provides a screw positioning sleeve assembly capable of quickly connecting a screw tool in accordance with a preferred embodiment of the present invention, and the screw tool is a screwdriver 50 in the present embodiment. The screwdriver 50 includes a rod body 51 having a front end provided with a locking portion 52 to be inserted into a locking groove 611 in an end portion 61 of a screw 60. When the screw 60 is screwed or unscrewed, the screw positioning sleeve assembly in accordance with the present invention is mounted on the rod body 51 so as to attract the head portion 61 of the screw 60. The screw positioning sleeve assembly in accordance with the present invention essentially comprises an outer sleeve 30 and an inner sleeve 20. The outer sleeve 30 is slidably mounted on the inner sleeve 20.

The inner sleeve 20 has a front open end and a rear open end that communicate with each other. A front flange 21 is defined on the front end of the outer surface of the inner sleeve 20, and a rear flange 22 is defined on the rear end of the outer surface of the inner sleeve 20. The inner sleeve 20 is mounted on the rod body 51 of the screwdriver 50.

The outer sleeve 30 has a front open end and a rear open end that communicate with each other. A restricting flange 31 is defined on the front end of the inner surface of the outer sleeve 30. A magnet 32 is disposed between the front end edge and the restricting flange 31 of the outer sleeve. A stopping flange 33 is defined on the rear end of the inner surface of the outer sleeve 30, and a plurality of open slots 34 is defined in the rear end of the outer sleeve. The rear end of the outer sleeve can expand by force through the open slots 34, so that the rear end of the inner sleeve 20 can expand to fit on the outer sleeve 30. After that, the slots will enable the outer sleeve 30 to restore to its original shape, and the stopping flange 33 and the front flange 21 will mate with each other to prevent the outer sleeve 30 and the inner sleeve 20 from disconnecting from each other, so that the outer sleeve 30 can move within a fixed travel length along the inner sleeve 20. Before the screw 60 is screwed or unscrewed by the screwdriver 50, the outer sleeve 30 will be moved to make the magnet 32 attract the head portion 61 of the screw 60. In addition, the moving distance of the outer sleeve 30 varies with the depth of the locking groove 611 of the screw 60 to position the screw 60 for facilitating the screwing/unscrewing operation.

Abovementioned is an illustration of the location and the structure of the respectively related subassemblies of the present invention. The structure and the subassemblies of the present invention are simply designed. A user can easily connect the inner sleeve with an ordinary screwdriver 50 to screw or unscrew a screw without pre-forming any additional preformed structure on the screwdriver 50. The following is the description of the operation state of the present invention:

Referring to FIGS. 3-4 and 7 again, the outer sleeve 30 of the present invention can be produced by plastic molding, so that the outer sleeve 30 has certain elasticity. By such an arrangement, when assembling the outer sleeve 30 and the inner sleeve 20, the rear end of the outer sleeve 30 can expand through the open slots 34, so that the stopping flange 33 of the outer sleeve 30 favourably passes through the front flange 21 of the inner sleeve 20. After that, the outer sleeve 30 restores its original shape, so that the stopping flange 33 and the front flange 21 are engaged with each other to prevent the outer sleeve 30 and the inner sleeve 20 disconnecting from each other.

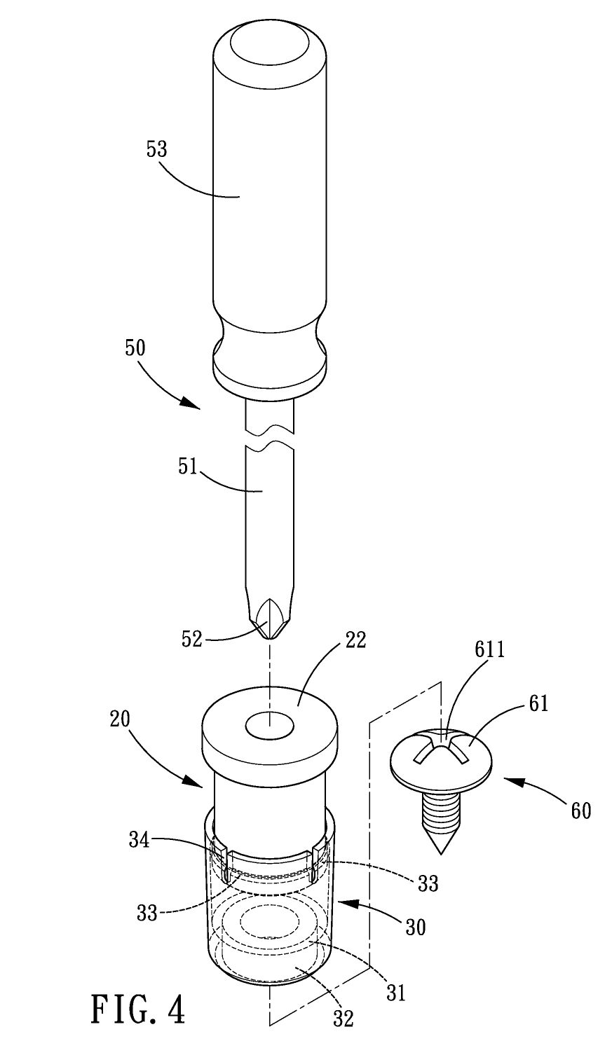

As shown in FIGS. 4, 5, and 7, the rod body 51 of the screwdriver 50 is normally in the form of a cylinder, the font end of the rod body 51 is provided with the locking portion 52 to be inserted into the head portion 61 of the screw 60, and the rear end of the rod body 51 is provided with a holding portion 53 to be held by the user. When the screwdriver 50 is combined to the screw positioning sleeve assembly of the present invention, the cylindrical rod body 51 of the screwdriver 50 can be directly inserted into the inner sleeve, so that the screwdriver 50 can be tightly fitted in the inner sleeve 20.

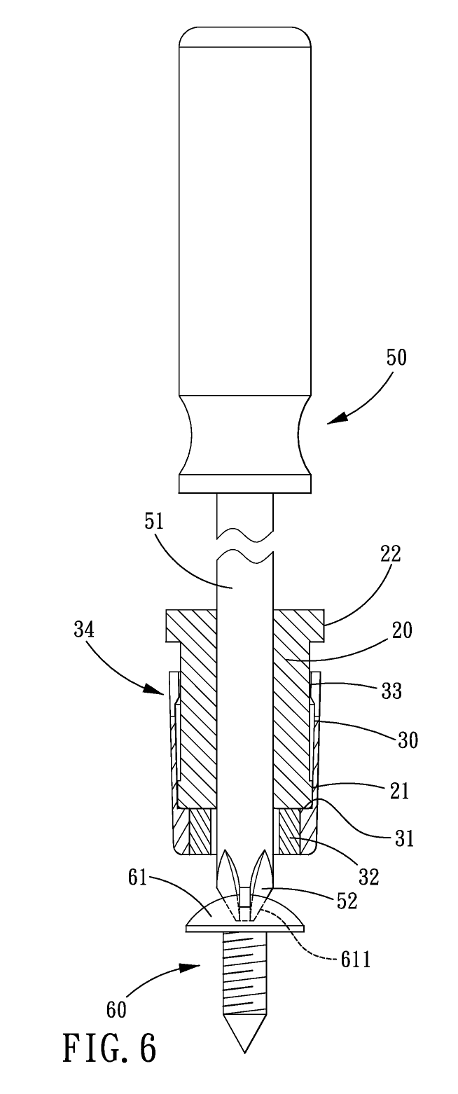

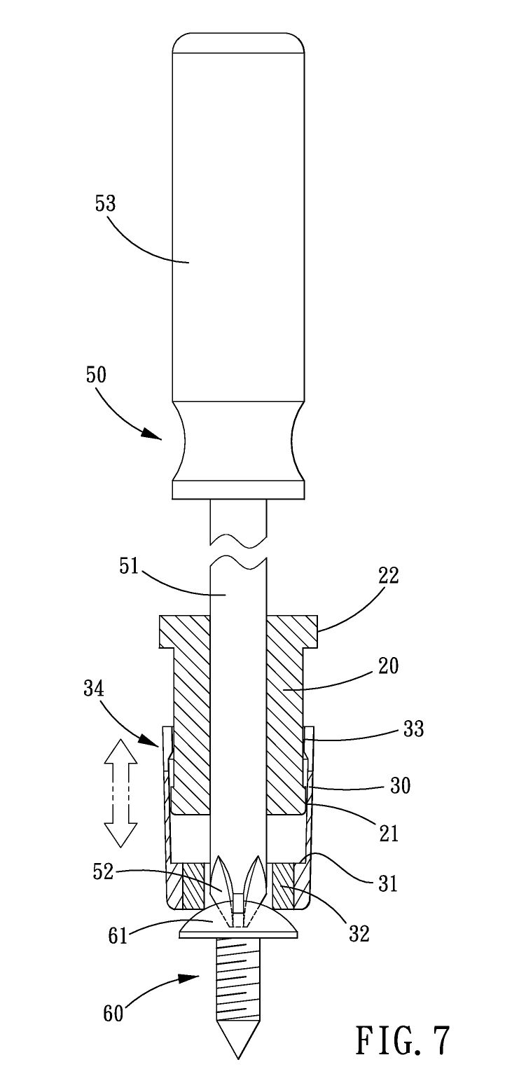

Referring to FIGS. 6-7, when the screw 60 is screwed or unscrewed, the magnet 32 on the outer sleeve 30 will magnetically attract the screw and drive the outer sleeve 30 to move towards the screw 60 synchronously until the magnet 32 contacts the head portion 61 of the screw 60. The moving distance of the outer sleeve 30 varies with the depth of the locking groove 611 of the screw 60. Therefore, when the screw 60 is screwed or unscrewed by the screwdriver 50, the outer sleeve 30 will keep magnetically attracting the head portion 61 of the screw 60 to prevent the fall-off of the screw 60 during the screwing/unscrewing operation.

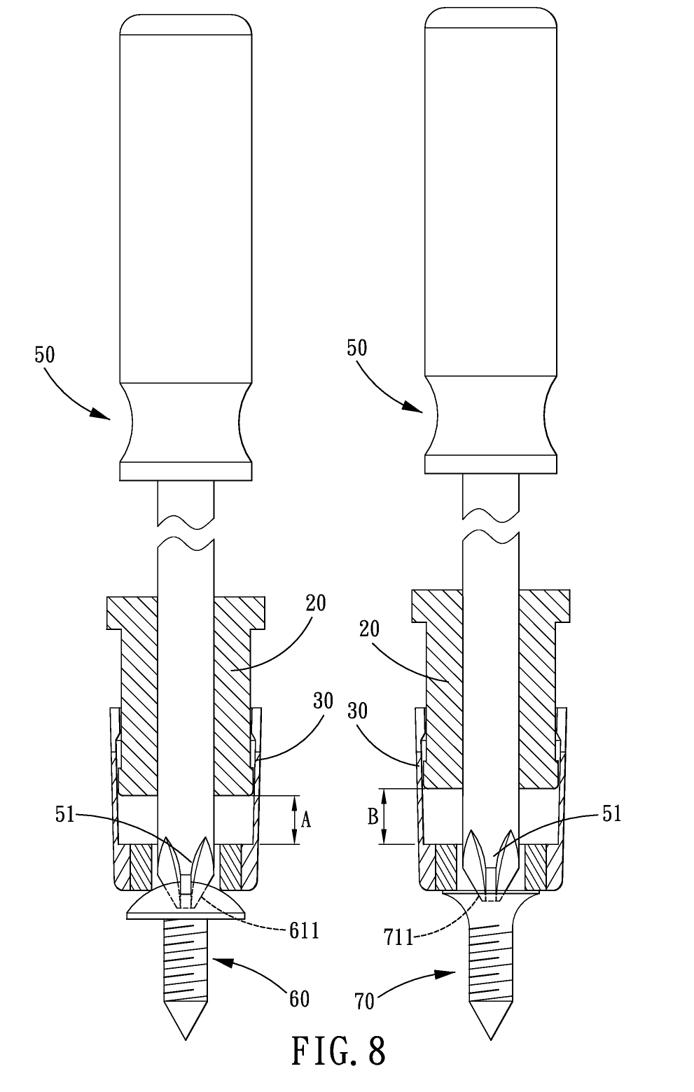

It is to be noted that, the inner sleeve is mounted on the rod body of the screwdriver, the outer sleeve moves on the inner sleeve, and the moving distance of the outer sleeve varies with the depth of the locking groove of the screw, namely, as shown in FIG. 8, the depth of the locking groove 611 of the screw 60 is bigger than the locking groove 711 of a first screw 70, so that if the screwdriver 50 is used to unscrew the screw 60 and the first screw 70 respectively, the moving distance A of the outer sleeve 30 of the screw positioning sleeve assembly which is applied to unscrew the screw 60 is smaller than the moving distance B of the outer sleeve 30 of the screw positioning sleeve assembly which is applied to unscrew the screw 70. Hence, with the structure design of the outer sleeve 30 capable of moving on the inner sleeve 20, the sleeve positioning sleeve assembly in accordance with the present invention is applicable to screws with different depths of locking grooves.

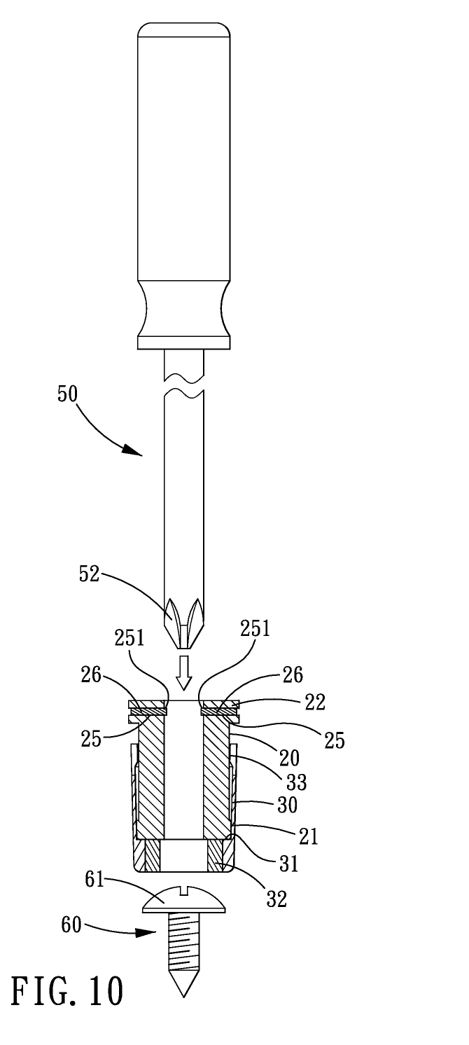

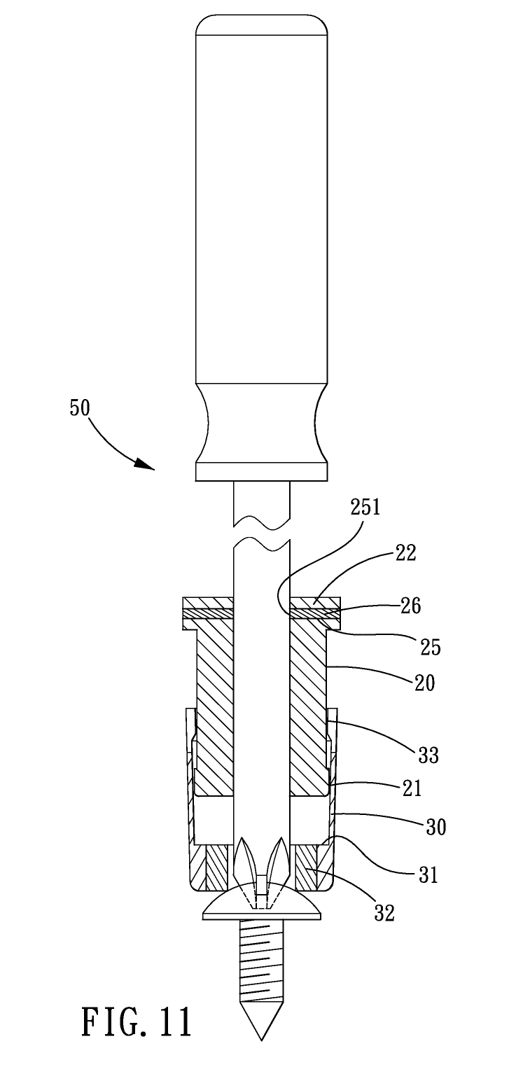

In addition, since the inner sleeve is directly mounted on the screwdriver, in order to prevent the screwdriver from disengaging from the inner sleeve uncontrollably, the following several measures can be taken. For example, as shown in FIG. 6, the rear open end of the inner sleeve 20 can be sized to be equal or close to the diameter of the rod body 51 of the screwdriver 50, so that the inner sleeve 20 can be tightly fitted on the screwdriver 50. Or as shown in FIG. 7, an annular recess 23 is defined in the rear end of the inner surface of the inner sleeve 20, a rubber 0-shaped ring 24 is engaged in the annular recess 23, and a part of the O-shaped ring 24 normally protrudes out of the annular recess 23, so that when inserting the screwdriver 50 in the inner sleeve 20, the O-shaped ring 24 can tightly clasp an outer surface of the screwdriver 50. Another measure is shown in FIGS. 10-11, an annular groove 25 is defined in the rear end of the outer surface of the inner sleeve 20, and a plurality of locking holes 251 in communication with the inner space of the inner sleeve 20 is defined in part of the annular groove 25, and a C-shaped clasp 26 is engaged in the annular groove 25 in such a manner that a part of the C-shaped clasp 26 is inserted in the inner sleeve through the locking holes 251, so that when inserting the screwdriver 50 in the inner sleeve 20, the C-shaped clasp 26 can tightly clasp the outer surface of the screwdriver 50 to position the tool rod.

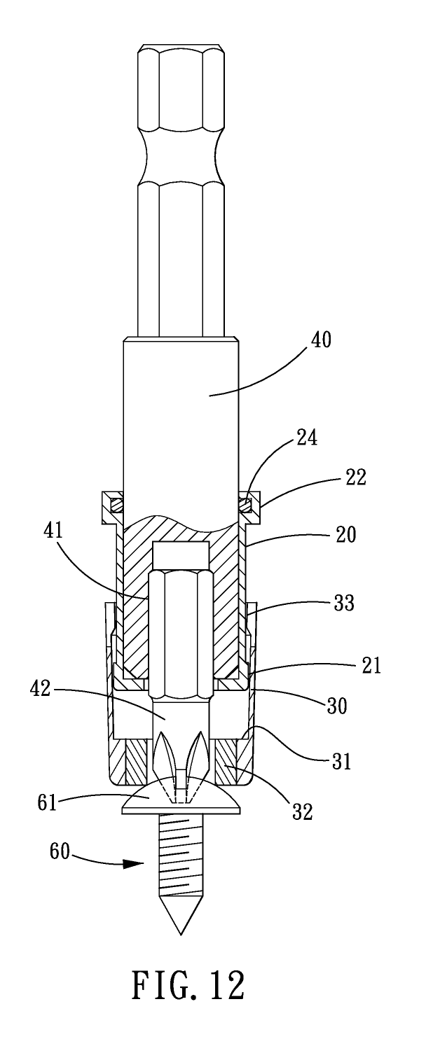

In addition, as FIG. 12, if the locking tool is a tool rod 40, it is also applicable to the screw positioning sleeve assembly in accordance with the present invention. The tool rod 40 is commonly defined in the front end thereof with an insertion groove 41 for insertion of a tool head 42 to screw/unscrew a screw. The front end of the tool rod 40 is normally in the form of a cylinder, and the rear end of the tool rod can be connected to a power driven tool or a hand tool (not shown). When the tool rod 40 is connected to the screw positioning sleeve assembly of the present invention, the cylindrical end of the tool rod 40 can be directly inserted into the rear end of the inner sleeve 20, and then the tool rod 40 will be tightly fitted in the inner sleeve 20 through the O-shaped ring, so that the tool rod 40 can cooperate with the screw positioning sleeve assembly of the present invention to screw or unscrew a screw.

To sum up, the screw positioning sleeve assembly of the present invention can be connected with an ordinary tool rod or a screwdriver to screw or unscrew a screw. In addition, the rod body of the tool rod or the screwdriver can connect with the screw positioning sleeve assembly of the present invention without needing any additional preformed structure such as an annular recess. Therefore, the scope of applicability of the screw positioning sleeve assembly is enlarged considerably.

While we have shown and described various embodiments in accordance with the present invention, it is clear to those skilled in the art that further embodiments may be made without departing from the scope of the present invention.

What is claimed is:

1. A screw positioning sleeve assembly capable of quickly connecting a locking tool, wherein the locking tool includes a rod body which is provided in a front end thereof with a locking portion to be inserted into a locking groove in a head portion of a screw to screw/unscrew the screw, the screw positioning sleeve assembly is engaged on the rod body to attract the head portion of screw, the screw positioning sleeve assembly comprises:
an inner sleeve has a front open end and a rear open end that communicate with each other, a front flange is defined on a front end of an outer surface of the inner sleeve, and a rear flange is defined on a rear end of the outer surface of the inner sleeve, the inner sleeve is mounted on the rod body of the locking tool;
an outer sleeve has a front open end and a rear open end that communicate with each other, a restricting flange is defined on a front end of an inner surface of the outer sleeve, a magnet is disposed between a front end edge and the restricting flange of the outer sleeve, a stopping flange is defined on a rear end of the inner surface of the outer sleeve, and a plurality of open slots is defined in the rear end of the outer sleeve, so that the rear end of the outer sleeve is expandable by force through the open slots, the rear end of the outer sleeve expands to fit on the inner sleeve, after that, the slots enable the outer sleeve to restore to its original shape, and the stopping flange and the front flange mates with each other to prevent the outer sleeve and the inner sleeve from disconnecting from each other, the outer sleeve is able to move on the inner sleeve, before the screw is locked by the locking tool, the outer sleeve is moved to attract the screw; and a moving distance of the outer sleeve varies with a depth of the locking groove of the screw.

2. The screw positioning sleeve assembly as claimed in claim 1, wherein an insertion groove is defined in a front end of the locking tool for insertion of the locking portion to screw or unscrew a screw.

3. The screw positioning sleeve assembly as claimed in claim 1, wherein the locking tool is a screwdriver.

4. The screw positioning sleeve assembly as claimed in claim 1, wherein an annular recess is defined in a rear end of an inner surface of the inner sleeve, a rubber O-shaped ring is engaged in the annular recess, and a part of the O-shaped ring protrudes out of the annular recess, so that after the locking tool is inserted in the inner sleeve, the O-shaped ring will tightly clasp an outer surface of the rod body to position the tool rod.

5. The screw positioning sleeve assembly as claimed in claim 1, wherein an annular groove is defined in the rear end of the outer surface of the inner sleeve, and a plurality of locking holes in communication with an inner space of the inner sleeve is defined in part of the annular groove, and a C-shaped clasp is engaged in the annular groove in such a manner that a part of the C-shaped clasp is inserted in the inner sleeve through the locking holes, so that after the rod body of the locking tool is inserted in the inner sleeve, the C-shaped clasp will tightly clasp the outer surface of the locking tool to position the tool rod.
